(19) United States
(12) Patent Application Publication
(10) Pub. No.: US 2004/0206613 A1
(43) Pub. Date: Oct. 21, 2004

(54) Network tap system and method

(75) Inventor: Lee J. Ward, Methuen, MA (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc.

(21) Appl. No.: 10/417,628

(22) Filed: Apr. 17, 2003

(51) Int. Cl. H01R 33/96

(52) U.S. Cl. 200/51.09

(57) ABSTRACT

A network tap system and method are disclosed. The system includes a housing, a first connection block, a second connection block, a third connection block, a device switch, and a communication port. The housing has a thermoplastic composition resin housing. The first connection block is configured to accept a first portion of a network trunk cable. The second connection block is configured to accept a second portion of a network trunk cable. The third connection is configured for connection to a network device. The device switch is configured to short the network trunk cable when the network device is not connected to the third connection. The device switch is configured to operate without the need for manual selection. The communication port is configured to accept a programming cable from a computer. The communication port is also configured for access while the housing is mounted on the DIN rail.

### TECHNICAL FIELD

The present invention is generally related to a system and method for controlling industrial devices and in particular, a network tap system and method.

### BACKGROUND

Local area networks are widely used for communicating between data processing systems and peripherals in industrial control systems. Such local area networks, data processing systems, and peripherals are disclosed in U.S. Pat. No. 6,016,523 and German Patent No. DE 196 15 093 A1, that are incorporated herein by reference. Flexibility in industrial control systems is desired in order to accommodate changes to the industrial process; such as the addition of new equipment, and the monitoring and control of the system from diverse points in the network.

A data processing system may be a controller. A controller is any device that receives inputs, acts on the inputs, and generates outputs in response to the inputs. Controllers include devices such as, but not limited to, Programmable Logic Controllers (PLC) and field bus couplers. PLCs and field bus couplers coordinate interaction among connected input and output modules on a communication bus. Typically, the controller monitors the modules and facilitates actions within the control system. PLCs provide a replacement for hard-wired relay and timer logic circuits found in traditional control panels. PLCs offer flexibility in process control since their behavior is based on executing simple programmed logical instructions. PLC installation is generally easier than relay and logic circuits, and amendments are easier to implement. Most modern PLCs offer internal functions such as timers, counters, shift registers, and special functions making sophisticated control possible using even the most modest PLC.

PLCs offer standard input and output interfaces that suit most process plant equipment and machinery. Standard input interfaces are available that permit direct connection to process transducers. Standard output interface circuitry will usually permit direct connection to contactors that energize process actuators such as motors, pumps and valves. Modern PLCs also have the ability to communicate with networks. A user may now monitor and control PLCs from remote locations.

Input and output modules include sensors, relays, gauges, valves, message displays, switches, limit switches, proximity switches, motor starters, motor controllers, and other like devices as well as traditional Input/Output (I/O) modules for control systems. The input module monitors, or senses, a condition. A signal representing the condition is received by the input module and transmitted to the PLC for processing. The PLC utilizes the representative signal according to a specific function. Generally, the function requires the PLC to perform an operation related to the signal and transmit the result of the operation to the appropriate output module. In this way, the PLC may monitor inputs of a process under control and possibly from the network. Based on the program being executed in memory, the PLC may energize appropriate outputs. The control operating system, which controls the behavior of the PLC, can be modified permitting the entire operation of the external hardware to be altered without the need to disconnect or reroute wiring.

Industrial control systems may use at least one of many network protocols for passing data along the network. Widely used network protocols include the MODBUS®, MODBUS Plus, and Ethernet Transport Control Protocol/Internet Protocol (TCP/IP). The MODBUS® protocol was developed by Modicon in 1978 as a simple way for transferring control data between controllers and sensors using an RS232 port. The MODBUS® protocol is also compatible with the Ethernet port 502. Since its creation, the MODBUS® protocol has become an industry standard. Today's MODBUS® protocol is the single, most supported protocol amongst automation devices. This effort has been complemented opportunely with the assignment of the well-known Ethernet port 502

Flexible access to the industrial control system has been provided, to some degree, by network tap devices such as those described in Modicon Publication Number 043505142 entitled “Modicon 990 NAD 230 00 Modbus Plus Tap which is entirely incorporated herein by reference. Though the MODBUS® protocol has led to greater flexibility in industrial control system automation, there is still a need for simpler and more flexible access to the network throughout the control system.

### SUMMARY

The present invention provides a system and method for controlling industrial devices and in particular a network tap system and method. The network tap system includes a housing, a first connection block, a second connection block, a third connection block, a device switch, and a communication port.

The housing has a thermoplastic composition resin housing and is configured for mounting on a DIN rail. The first connection block is configured to accept a first portion of a network trunk cable. The second connection block is configured to accept a second portion of the network trunk cable. The third connection is configured for connection to a network device.

A device switch is configured to short the network trunk cable when the network device is not connected to the third connection. The device switch is configured to operate without the need for manual selection.

A communication port is configured to accept a programming cable from a computer. The communication port is also configured for access while the housing is mounted on the DIN rail.

The present invention can also be viewed as providing a method for accessing a network. The method is directed to facilitating connection of a network device to a system utilizing a DIN rail. The method includes providing a first connection block being capable of accepting a first portion of a network trunk cable. A second connection block is provided and is capable of accepting a second portion of the network trunk cable. A third connection block is provided and capable of connecting to a network device. A device switch having a first and second state responsive to a presence of the network device operably connected to the third connection is provided. The network device is received in the third connection block wherein the first and second portions of the network trunk cable are isolated in response to the network device being received in the third connection block.

A further aspect of the method of the present invention includes operably connecting the first and second portions of the network trunk in response to the network device being removed from the third connection block.

Other systems, methods, features, and advantages of the present invention will be apparent, or will become apparent, to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is block diagram of a control system including a network tap system. The network tap system includes a housing mounted on a DIN rail.

FIG. 2 is a block diagram of one side of the housing of FIG. 1.

### DETAILED DESCRIPTION

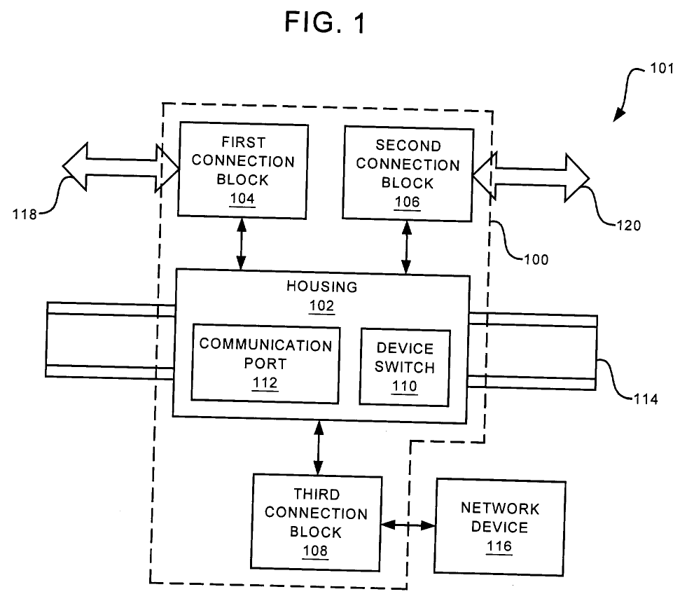

The present invention is generally related to a network tap system and method for an industrial control system. FIG. 1 is block diagram of a control system 101 including a network tap system 100. The network tap system 100 includes a housing 102, a first connection block 104, a second connection block 106, a third connection block 108, a device switch 110, and a communication port 112. The network tap device 100 is shown mounted on a DIN (German Institute for Standardization) rail 114.

The housing 102 may be formed from a variety of materials, such as a thermoplastic resin composition, plastic, and metal. The housing is configured to be mountable on the DIN rail 114. The housing includes terminals (not shown in FIG. 1) for electrical and data communication with the first, second, and third connection blocks 104, 106, and 108. The DIN rail 114 may be mounted on a variety of places such as in an electrical enclosure, an electrical cabinet, and a motor control center. The housing may have an IP (Ingress Protection) rating of IP2X.

The first connection block 104 is configured for pre-wiring. First connection block 104 may be separately mountable from the housing 102 in order that the first connection block 104 may be mounted using fasteners, e.g., screws, prior to mounting the housing 102 on the DIN rail 114. First connection block 104 is connected to a first portion 118 of a network trunk cable.

The second connection block 106 is also configured for pre-wiring. The second connection block 106 may be separately mountable from the housing 102 in order that the first connection block 106 may be mounted using fasteners, e.g., screws, prior to mounting the housing 102. The second connection block 106 is connected to a second portion 120 of the network trunk cable.

Similarly, the third connection block 108 is also configured for pre-wiring. The third connection block 108 may be separately mountable from the housing 102 in order that the third connection block 108 may be mounted using fasteners, e.g., screws, prior to mounting the housing 102. The third connection block 108 is shown in FIG. 1 connected to network device 116.

The first, second and third connection blocks 104, 106, and 108 are configured such that when they are mounted, for example in an electrical panel, the housing 102 may be placed between them and secured to the DIN rail 114 such that the contacts associated with the first, second, and third connection blocks 104, 106, and 108 are operatively connected to the terminals associated with the housing 102

A device switch 110 includes a first and second state. The device switch 110 is configured to be adapted to the first state wherein the first and second portions 118, 120 of the network trunk cable are operably connected, e.g., shorted, in response to the network device 116 not being connected to the third connection block 108. In contrast, FIG. 1 shows the device switch 110 in its second state wherein network device 116 connected to third connector block 108). The device switch 110 is configured to recognize whether the network device 116 is connected to the third connector block 108 and to operate accordingly.

A communication port 112 is configured to accept a programming cable from a computer. For example, communication port 112 may be an RJ port. The communication port 112 is associated with the housing 102 such that the communication port is accessible when the housing is mounted on the DIN rail 114. Thus, the communication port 112 may be placed on the opposite side of the housing 102 from the DIN rail mounting components (not shown) associated with the housing. Communication port 112 is configured to allow programming via the communication port 112.

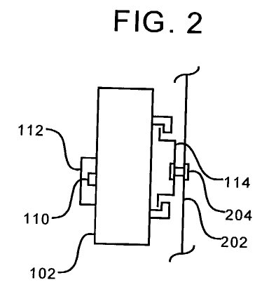

FIG. 2 is a block diagram of one side of the housing of FIG. 1. FIG. 2 shows the housing mounted on a panel 202. The panel 202 supports the DIN rail 114 by using a securing device 204. The securing device 204 may be any securing device such as a screw or a rivet, etc. The housing 102 is secured to the DIN rail 114 using DIN rail mounting components.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. An network system, comprising:
a first connection block being capable of accepting a first portion of a network trunk cable;
a second connection block being capable of accepting a second portion of the network trunk cable;
a third connection block being capable of connecting to a network device; and, a device switch having a first and second state responsive to a presence of the network device operably connected to the third connection, the first state operably isolating the first and second portions of the network trunk cable in response to the network device being connected to the third connection block, the second state operably connecting the first and second portions of the network trunk in response to a network device not being connected to the third connection block.

2. The network system of claim 1 wherein the device switch being configured to operate without manual selection.

3. The network system of claim 1 further comprising:
a housing,
the first, second, and third connection blocks being adaptable for drop-in connection to the housing.

4. The network system of claim 3 wherein the housing includes a thermoplastic composition resin and adaptable for mounting on a DIN rail.

5. The network system of claim 4 further comprising:
a communication port being adapted to accept a programming cable from a computer, the communication port being configured for access while the housing is mounted on the DIN rail.

6. The network system of claim 1 wherein the first, second, and third connection blocks being configurable for pre-wiring.

7. An network tap system, comprising:
a housing, the housing having a thermoplastic composition resin and configured for mounting on a DIN rail;
a first connection block, the first connection block configured for pre-wiring, the first connection block configured to accept a first portion of a network trunk cable, the first connection block configured for drop-in connection to the housing;
a second connection block, the second connection block configured for pre-wiring, the second connection block configured to accept a second portion of a network trunk cable, the second connection block configured for drop-in connection to the housing;
a third connection block, the third connection block configured for pre-wiring, the third connection block configured to accept a connection from a network device, the third connection block configured for drop-in connection to the housing;
a device switch, the device switch configured to short the first and second portions of the network trunk cable when a network device is not connected to the third connection, the device switch configured to operate without manual selection; and,
a communication port configured to accept a programming cable from a computer, the communication port further configured for access while the housing is mounted on the DIN rail.

8. A method for facilitating connection of a network device to a system utilizing a DIN rail, the method comprising the steps of:
providing a first connection block being capable of accepting a first portion of a network trunk cable;
providing a second connection block being capable of accepting a second portion of the network trunk cable;
providing a third connection block being capable of connecting to a network device; and,
providing a device switch having a first and second state responsive to a presence of the network device operably connected to the third connection;
receiving a network device in the third connection block; and,
isolating the first and second portions of the network trunk cable in response to the network device being received in the third connection block.

9. The method of claim 8 further including the step of:
operably connecting the first and second portions of the network trunk in response to the network device being removed from the third connection block.
